(19) United States
(12) Patent Application Publication
(10) Pub. No.: US 2009/0009396 A1
(43) Pub. Date: Jan. 8, 2009

(54) METHOD AND APPARATUS FOR LOCATIONING USING DVB-T DIGITAL TELEVISION SIGNALS

(75) Inventor: LIN YANG, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/772,477

(22) Filed: Jul. 2, 2007

(51) Int. Cl. G01S 3/02

(52) U.S. Cl. 342/450

(57) ABSTRACT

A receiver for positioning using DTV signals is provided. The receiver comprises the step of calculating a transmission time of at least one pilot signal among a plurality of pilot signals disposed within a digital television (DTV) signal or information originating from a transmitter and transmitted to a mobile receiver.

### CROSS-REFERENCE TO OTHER APPLICATIONS

The following applications of common assignee are related to the present application, and are herein incorporated by reference in their entireties:

U.S. patent application Ser. No. 11/744,824 to Yang, entitled “METHOD AND APPARATUS FOR DECISION FEEDBACK LOCATIONING USING DIGITAL TELEVISION SIGNALS” with attorney docket number LSFFT-064.

U.S. patent application Ser. No. 11/770,651 to Yang, entitled “METHOD AND APPARATUS FOR POSITIONING USING ATSC DIGITAL TV SIGNALS” with attorney docket number LSFFT-063.

### FIELD OF THE INVENTION

The present invention relates generally to locationing or determining the exact location of a fixed or moving object, more specifically the present invention relates to feedback locationing using digital television signals associated with Digital Video Broadcasting—Terrestrial standard, which is the DVB European consortium standard for the broadcast transmission of digital terrestrial television.

### BACKGROUND

Locationing using GPS signals is known.

Digital TV signals is known to be used for receiving digital programs for watching. However, digital signals are known to be used for locationing purposes. U.S. Published Patent Application No. 20070008220 to Matthew Rabinowitz et al describes an apparatus to determine the position of a user terminal, the apparatus having corresponding methods and computer-readable media, comprises a receiver to receive, at the user terminal, a wireless orthogonal frequency-division multiplexing (OFDM) signal comprising a scattered pilot signal; and a processor to determine a pseudo-range based on the scattered pilot signal; wherein a position of the user terminal is determined based on the pseudo-range and a location of a transmitter of the OFDM signal.

However, the scattered pilots are not modulated by data. This is advantageous in that all of the power in the scattered pilots is available for position determination, and none of the power is devoted to data portion of the DTV frame.

### SUMMARY OF THE INVENTION

A method and apparatus for positioning using a known portion of a DTV signals is provided.

A method and apparatus for positioning using at least one pilot signal of a DTV signals is provided.

A method and apparatus for positioning using DTV signals is provided. The method comprises the step of calculating a transmission time of at least one pilot signal among a plurality of pilot signals disposed within a digital television (DTV) signal or information originating from a transmitter and transmitted to a mobile receiver.

A mobile receiver for positioning is provided. The mobile receiver comprising a method including the step of calculating a transmission time of at least one pilot signal among a plurality of pilot signals disposed within a digital television (DTV) signal or information originating from a transmitter and transmitted to the mobile receiver.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1. is an example position locationing system in accordance with some embodiments of the invention.

FIG. 2 is an example digital television signal in accordance with some embodiments of the invention.

FIG. 3 is an example position locationing device in accordance with some embodiments of the invention.

FIG. 4 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to positioning using a known portion of a DTV signals. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of positioning using a known portion of a DTV signals described herein. The non-processor circuits may include, but are not limited to, a radio receiver, a radio transmitter, signal drivers, clock circuits, power source circuits, and user input devices. As such, these functions may be interpreted as steps of a method to perform positioning using a known portion of a DTV signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention uses existing components of an exiting OFDM receiver whenever practicable. The present invention contemplate the positioning actions in the European digital video broadcast schemes such as DVBT (EU).

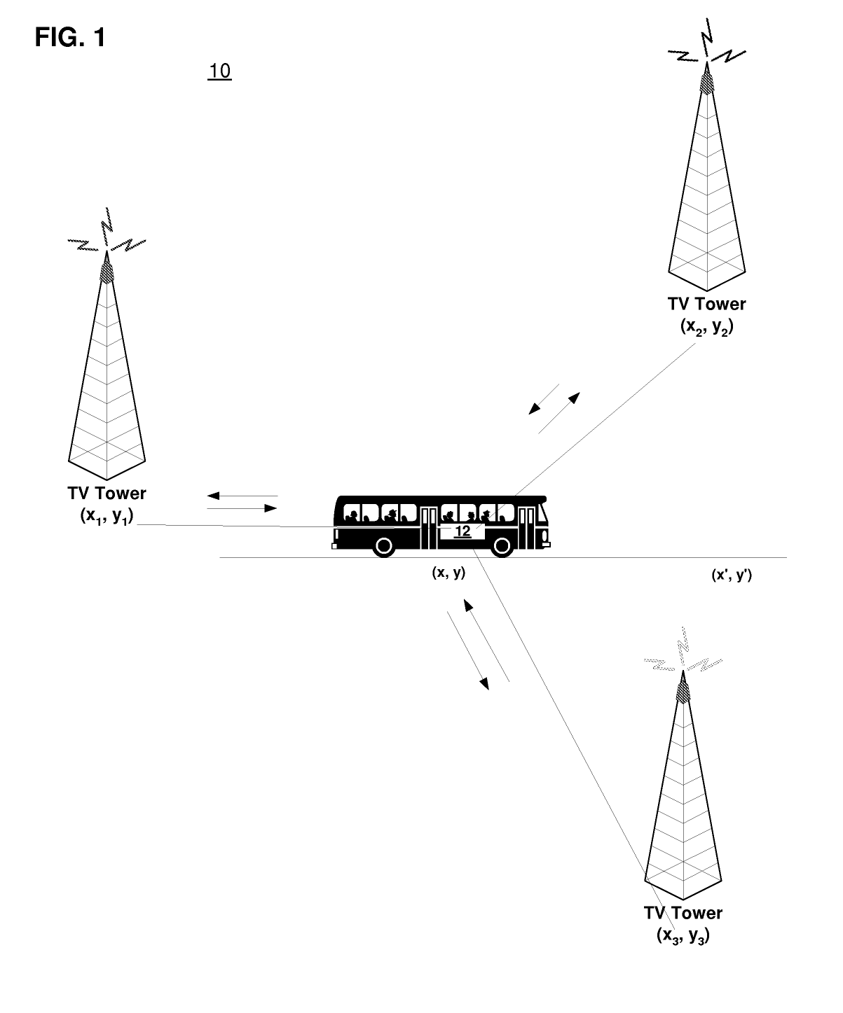

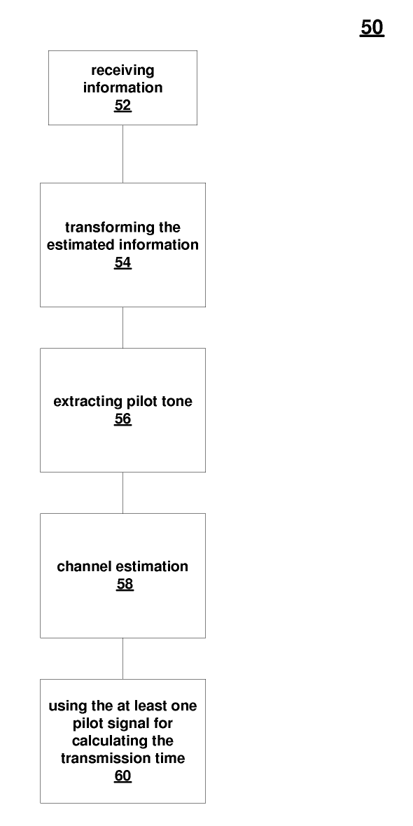

Referring to FIGS. 1-4, depictions of the present invention are shown. A positioning system 4 using known digital television (DTV) signals such as pilot signals is shown. Three DTV transmitters are provided with each transmitting at least a sufficient number of pilot signals suitable for a positioning. They are respectively: transmitter tower 1 having a predetermined position of (x₁, y₁); transmitter tower 2 having a predetermined position of (x₂, y₂); and transmitter tower 3 having a predetermined position of (X₃, y₃). A moving object 6 such as a moving vehicle having users carrying hand held devices is provided. The hand held devices comprise at least part of a DTV receiver. Moving object 6 has a variable position (x, y). The positioning of moving object 6 comprises determine the position (x, y) at time t. Typically, the distance d₁ is defined as the distance between (x₁, y₁) and (x, y). Similarly, d₂ is defined as the distance between (x₂, y₂) and (x, y); as well as d₃ being the distance between (X₃, y₃) and (x, y). As can be seen, when moving object 6 moves to a new point (x′, y′), distances between (x₁, y₁) and (x′, y′) changes. Similarly, new d₂ and d₃ need to be derived. Using the three towers each having known position to derive a positioning of moving object 6 is shown in detail in FIG. 3. Once the distance is known, the positioning of moving object 6 can be derived using any type of positioning in a known manner such as triangulation, etc.

As can be seen, only a two dimensional (2D) scheme is shown. However, the present invention contemplates a three dimensional (3D) scheme as well by introducing a third variable z such that d₁-d₃ is define on a 3D co-ordinate or space with d₁ being the distance between (x₁, y₁, z₁) and (x, y, z). Similarly, d₂ is defined as the distance between (x₂, y₂, z₂) and (x, y, z); and d₃ is defined as the distance between (x₃, y₃, z₃) and (x, y, z).

It is noted that unknown data segments are so referred because a mobile receiver does not know the various parameter including timing or clock info related therewith. For example, data segments or part of a DTV program information may constantly change. Therefore, data segments are unknown as compared to pilot signals that are known. In addition, unknown data segments typically occupy more space or takes more time than a typical pilot signal as the purpose of the DTV information is for a viewer to watch DTV programs which comprises virtually all of the unknown data segments. The present invention contemplates the use of only known signals such as pilot signals. The present invention does not use unknown signals.

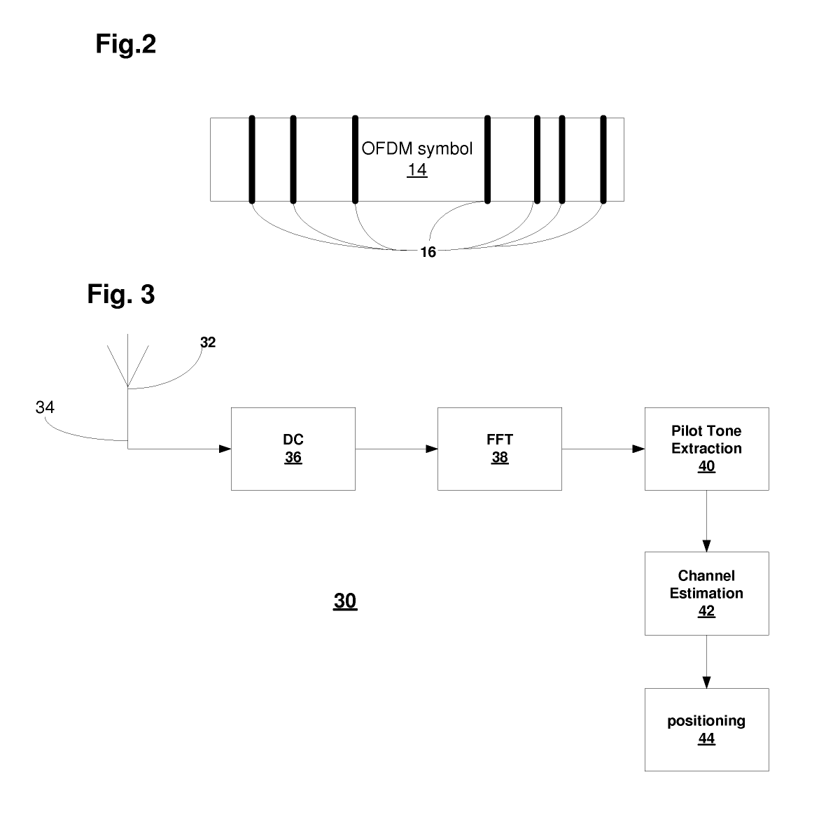

In FIG. 2, a depiction of a part of a frame in an OFDM communication systems having unknown OFDM symbols 14 and a plurality of pilot signals 16 is provided. The unknown OFDM symbols 14 comprise the information adapted to carry TV programming information. Pilot signals 16 are known signals that are used for positioning.

Referring now to FIG. 3, a block diagram 30 of at least part of a receiver is shown. An antenna 32 receives wireless signals including pilot signals 16. The received signal 34 is subjected to a front-end ADC 36 such that the analog RF signal may be converted to base-band and transformed into a digital signal, using an analog-to-digital converter (ADC). In turn, Fast Fourier transform 38 transformed the digital information into a different domain. At this juncture, various actions may be performed. The actions include time and frequency synchronization wherein digital base band signal is searched to identify the beginning of frames and blocks using pilot signals. The problems on the frequency of the components of the signal may be corrected herein as well. Continual pilots such as pilot 16 (whose value and position is pre-determined in a scheme and is therefore known by the receiver) may be used to determine the frequency offset suffered by the signal. This frequency offset might have been caused by Doppler effect, inaccuracies in either the transmitter or receiver clock, and so on. The pilot signals 16 may be used to equalize the received signal.

Hereinafter, channel estimation is performed 42. The estimated channel parameters can be used to extract the distance information for positioning 44 in that the restored known signals or the estimated information can be used to determine a timing difference. In other words, the actual measurement of travel time between a base station (e.g. TV tower 1) and a mobile station (e.g. mobile device 12) can be scheaved.

By way of an example, the estimated information is used for positioning purposes in block 44 may be as follows. Referring specifically to block 44, the received pilot signal sequences 16 therein is used for the processing of a positioning system. The distances d₁, d₂, and d₃ or the value of (x, y, z) may be measured as follows. By receiving from the 3 TV transmitters TV signals, a time offset between a local clock of that TV transmitter and a reference clock is established. The reference clock may be derived from GPS signals. The use of a reference clock permits the determination of the time offset for each TV transmitter when multiple monitor units (only one shown) are used. Because each monitor unit can determine the time offset with respect to the reference clock, the offsets in the local clocks of the monitor units do not affect these determinations. Alternatively, no external time reference is needed. According to this implementation, a single monitor unit receives TV signals from all three TV transmitters. The single monitor is a built-in device within a user terminal. In effect, the local clock of the single monitor unit functions as the time reference. The single monitor unit and the user terminal are combined as a single unit. Other actions of the receiver such as OFDM demodulation, demapping, internal deinterleaving, internal decoding such as using the Viterbi algorithm, external deinterleaving, and external decoding may not be need for positioning purposes.

The present invention contemplates positioning in block 44 using parameter extraction means. The parameter extraction comprises Window-FFT, and singular value decomposition (SVD), or filter bank, etc.

In Window-FFT, essentially because Fast Fourier Transform is an approximation of the standard Fourier Transform (i.e. using a time limited set of data), the beginning and end parts of this limited data set may lead to aliasing effects (i.e. yielding not existing frequency peaks). The case is especially true in using small data sets, whereby aliasing may lead to unwanted results. Therefore, in order to reduce aliasing, the data set can be preprocessed using special windows, wherein each window reduces the values at the begin and end of the data set in order to reduce the aliasing effects. Window-FFT comprises: using Hamming Window, Hann Window, and Quadratic Window.

A filter bank is an array of band-pass filters that separates the input signal into several components, each one carrying a single frequency subband of the original signal. Filter banks can be designed such that subbands can be recombined to recover the original signal. The first process is called analysis; and the second process is called synthesis.

In singular value decomposition, the singular value spectral theorem says that normal matrices can be unitarily diagonalized and used as a basis of eigenvectors. The SVD can be seen as a generalization of the spectral theorem to arbitrary, not necessarily square, matrices.

Referring to FIG. 4, a flowchart 50 of the present invention is shown. Flowchart 50 depicts a method for positioning comprising the step of calculating a transmission time of at least one pilot signal among a plurality of pilot signals disposed within a signal or information originating from a transmitter and transmitted to a mobile receiver. The transmitter may comprise an OFDM transmitter. Initially, a receiving side that may be part of a known receiver receives information including at least one pilot signal among a plurality of pilot signals of the television signal disposed within the transmitted information (Step 52). The received at least one pilot signal is subject to a transformation such as Fast Fourier Transform or FFT (Step 54). The transformed information including the least one pilot signal is subject to pilot tone extraction, wherein the known pilot signals are extracted (Step 56). The extracted pilot signal, in turn, is subjected to channel estimation (Step 58). The estimated pilot signal is used for positioning (Step 60). The processed pilot signal is used for calculating the transmission time between a transmission tower and the mobile user within a nationhood of a specific time period. If two or preferably three transmission tower exists, the position of the mobile user can be derived or calculated using such known method as triangulation, and the like.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for positioning comprising the step of calculating a transmission time of at least one pilot signal among a plurality of pilot signals disposed within a digital television (DTV) signal or information originating from a transmitter and transmitted to a mobile receiver.

2. The method of claim 1 further comprising the steps of:
receiving information including the at least one pilot signal;
transforming the estimated information; and
using the information including the at least one pilot signal for calculating the transmission time.

3. The method of claim 1 further comprising the step of performing a channel estimation upon the information including the at least one pilot signal.

4. The method of claim 1, wherein the television signal comprises at least one OFDM symbol.

5. The method of claim 1, wherein the digital television (DTV) signal comprises an OFDM signal having at least one pilot signal.

6. An apparatus for positioning comprising a method including the step of calculating a transmission time of at least one pilot signal among a plurality of pilot signals disposed within a digital television (DTV) signal or information originating from a transmitter and transmitted to a mobile receiver.

7. The apparatus of claim 6 further comprising the steps of:
receiving information including the at least one pilot signal;
performing a channel estimation upon the information including the at least one pilot signal;
transforming the estimated information; and
using the information including the at least one pilot signal for calculating the transmission time.

8. The apparatus of claim 6 further comprising the step of compensating the transformed information.

9. The apparatus of claim 6, wherein the television signal comprises at least one OFDM symbol.

10. The apparatus of claim 6, wherein the digital television (DTV) signal comprises an OFDM signal.

11. A mobile receiver for positioning comprising a method including the step of calculating a transmission time of at least one pilot signal among a plurality of pilot signals disposed within a digital television (DTV) signal or information originating from a transmitter and transmitted to the mobile receiver.

12. The receiver of claim 11 further comprising the steps of:
receiving information including the at least one pilot signal;
performing a channel estimation upon the information including the at least one pilot signal;
transforming the estimated information; and
using the information including the at least one pilot signal for calculating the transmission time.

13. The receiver of claim 11 further comprising the step of compensating the transformed information.

14. The receiver of claim 11, wherein the television signal comprises at least one OFDM symbol.

15. The receiver of claim 11, wherein the digital television (DTV) signal comprises an OFDM signal.
